(19) United States
(12) Patent Application Publication
(10) Pub. No.: US 2014/0123743 A1
(43) Pub. Date: May 8, 2014

(54) Fuel Usage Meter

(71) Applicants: James P. Shoen, Phoenix, AZ (US); Dean Cerimeli, Gilbert, AZ (US); Jeremy Donohue, Gilbert, AZ (US)

(72) Inventors: James P. Shoen, Phoenix, AZ (US); Dean Cerimeli, Gilbert, AZ (US); Jeremy Donohue, Gilbert, AZ (US)

(21) Appl. No.: 14/071,788

(22) Filed: Nov. 5, 2013

Related U.S. Application Data
(60) Provisional application No. 61/724,158, filed on Nov. 8, 2012.

(51) Int. Cl. G01M 15/04; G01F 9/00

(52) U.S. Cl. CPC G01M 15/042; G01F 9/00
USPC 73/114.52

(57) ABSTRACT

A method and apparatus are provided for displaying an accumulated fuel usage to a driver of a rental vehicle, such as a rental truck. The rental vehicle has a fuel usage meter that incudes a digital display for displaying fuel consumption of a rental vehicle to a rental customer. The customer is instructed to reset the accumulated fuel consumption display to zero when the customer takes possession of the vehicle and is instructed to read the accumulated fuel consumption display before returning the vehicle to determine an amount of fuel consumed during the rental of the vehicle. The meter retains the accumulated fuel consumption when the engine is turned off, when the meter is uncoupled from the data bus of the vehicle, and when vehicle power is disconnected from meter.

### RELATED APPLICATION

This application claims the benefit of U.S. Provisional Application No. 61/724,158, filed Nov. 8, 2012, entitled “Fuel Usage Meter,” which is incorporated herein by reference.

### BACKGROUND

This invention relates to a fuel usage meter for use with rental vehicles. More particularly, it relates to a device for measuring the fuel usage of a rental vehicle and displaying the accumulated fuel consumption to a rental customer.

It is an object of the present invention to enable a vehicle rental customer to accurately determine the amount of fuel used during their rental so that the customer can more precisely refuel the tank of the rental vehicle to a specified level before returning the vehicle.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in this specification.

### SUMMARY

To achieve the foregoing objects, and in accordance with the purposes of the invention as embodied and broadly described in this document, there is provided a method for displaying an accumulated fuel usage to a driver of a rental vehicle, such as a rental truck. The method includes providing a rental vehicle having a fuel usage meter that incudes: a digital display for displaying fuel consumption of a rental vehicle; input circuitry coupled to a data bus of the vehicle for receiving on-board diagnostic data from an engine computer; a processor coupled to the input circuitry and configured to calculate an accumulated fuel consumption using the on-board diagnostic data received from the engine computer; a memory device coupled to the processor for storing data; output circuitry coupled to the processor for outputting the accumulated fuel consumption to the digital display; and a reset input coupled to the processor for resetting the accumulated fuel consumption display to zero. The processor and memory are configured to retain the accumulated fuel consumption until the reset input is manually activated. The fuel consumption of the rental vehicle is displayed to the customer with the fuel consumption meter. A rental customer is instructed to reset the accumulated fuel consumption display to zero when the customer takes possession of the vehicle and is instructed to read the accumulated fuel consumption display before returning the vehicle to determine an amount of fuel consumed during the rental of the vehicle.

According to one aspect of the invention, the processor and memory can be configured to retain the accumulated fuel consumption when the engine is turned off. The processor and memory also can be configured to retain the accumulated fuel consumption when the fuel usage meter is uncoupled from the data bus of the vehicle and when vehicle power is disconnected from the fuel usage meter.

In one advantageous embodiment, the fuel usage meter digital display is mounted above the dashboard of the vehicle and is configured to calculate and display fuel consumption in hundredths of units.

In this configuration, the method and apparatus of the invention allow the customer to clearly determine a measure of how much fuel the vehicle has used during their rental.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 shows a front elevation view of one embodiment of a fuel usage meter in accordance with the present invention.

FIG. 2 shows a side elevation view of the fuel usage meter of FIG. 1, including one embodiment of a cable assembly for connecting to a vehicle on-board diagnostics connector.

FIG. 3 shows a front view of the fuel usage meter of FIG. 1 mounted inside the cab of a vehicle, displaying the gallons consumed and showing the reset button.

FIG. 4 shows the fuel usage meter of FIG. 1 mounted inside the cab of a vehicle above the dashboard.

FIG. 5 shows further details of the cable assembly of FIG. 2.

FIG. 6 shows further details of the connector of the cable assembly of FIG. 5 for connecting to the cable to the vehicle on-board diagnostics connector.

### DESCRIPTION

Reference in this application is made to presently preferred embodiments and methods of the invention. While the invention is described more fully with reference to these examples, the invention in its broader aspects is not limited to the specific details, representative devices, and illustrative examples shown and described. Rather, the description is to be understood as a broad, teaching disclosure directed to persons of ordinary skill in the appropriate arts, and not as limiting upon the invention.

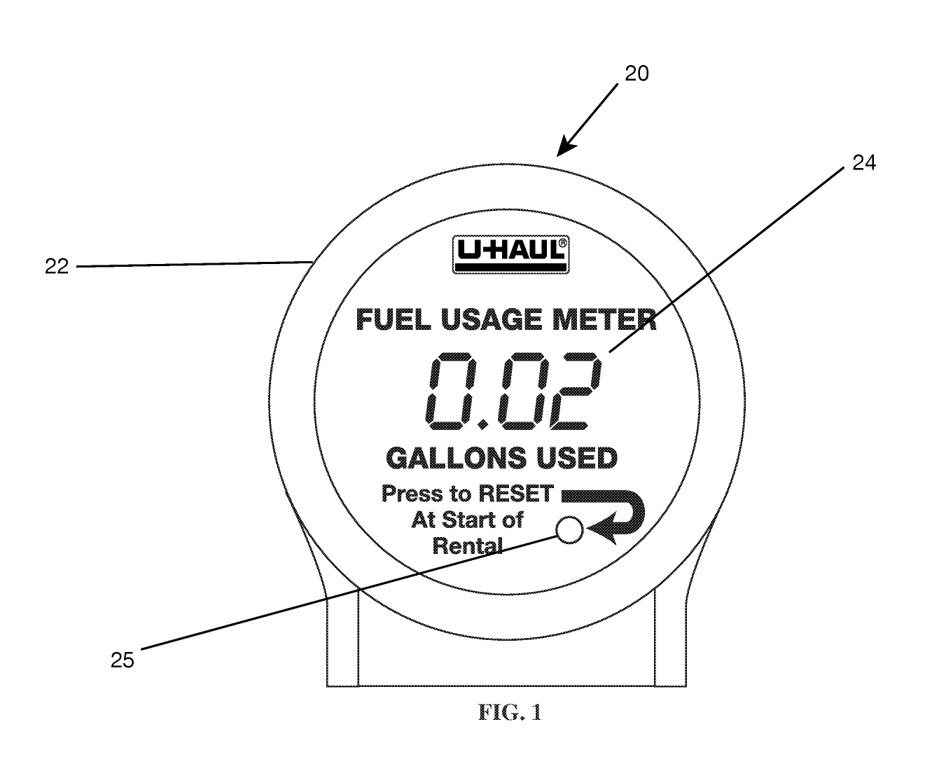

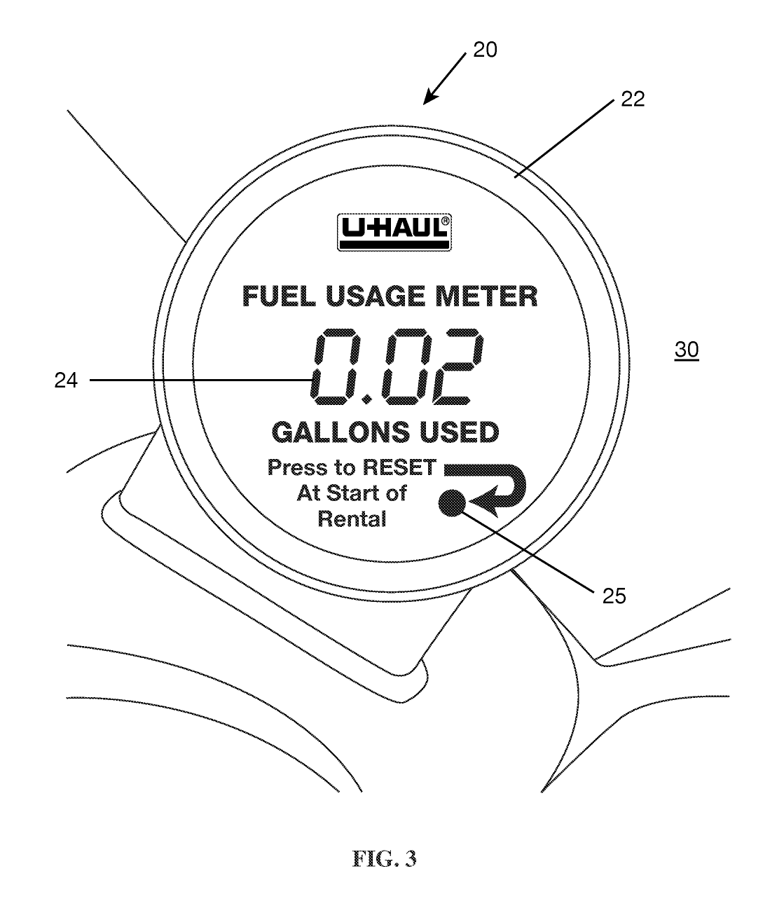

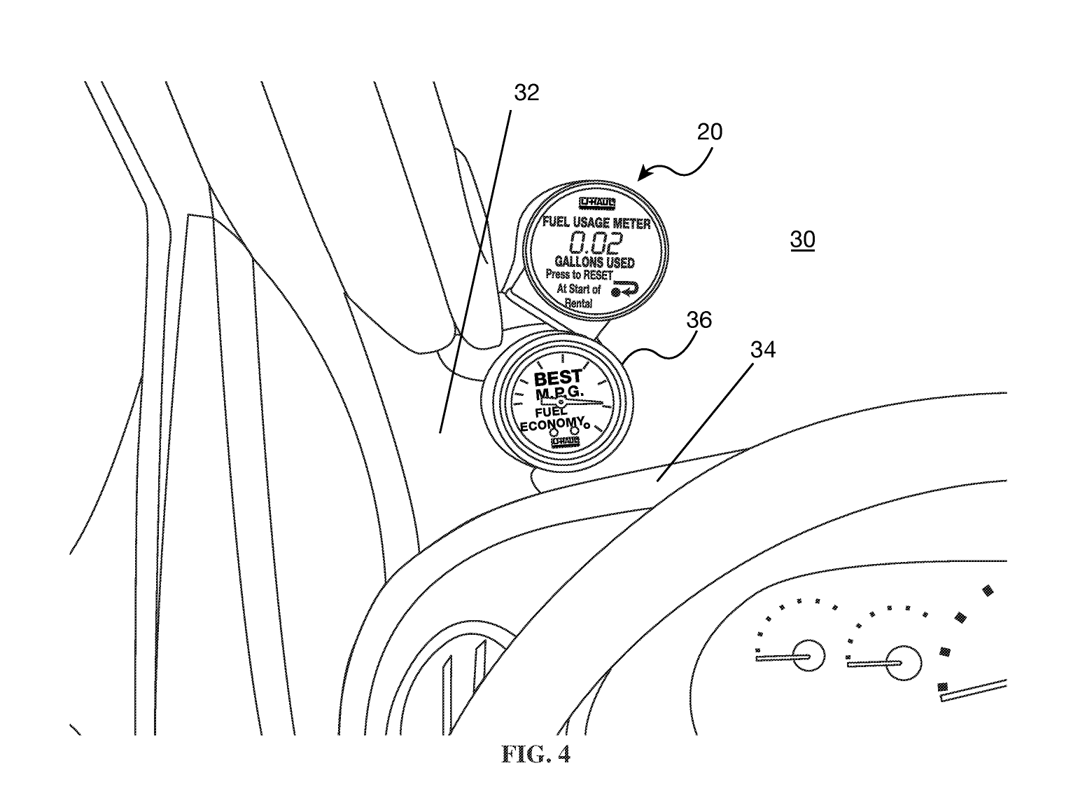

Referring to FIGS. 1-3, a presently preferred embodiment of a fuel usage meter 20 according to the present invention is shown. The meter 20 includes a housing 22 that has a digital display 24 for displaying fuel consumption. A reset button 25 is provided on the face of the meter 20. The fuel usage meter 20 is mounted inside the cab of the vehicle where it can be easily seen by the driver, as shown in FIGS. 3 and 4. Within the housing 22 is a processor (not shown) for making the necessary calculations to determine accumulated fuel consumption using data received by the processor.

As shown in FIG. 4, in one presently preferred embodiment, the fuel usage meter 20 is mounted in the vehicle cab over the a dashboard 34 toward the driver's side of the windshield 30 so that it is easily accessible to the driver.

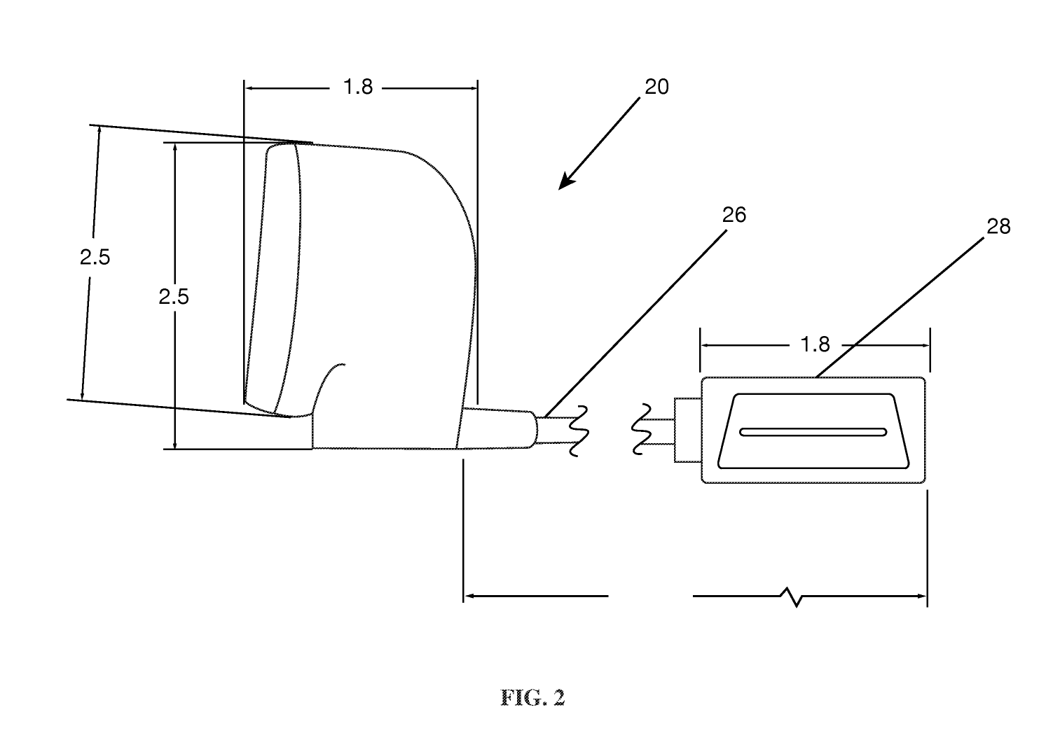

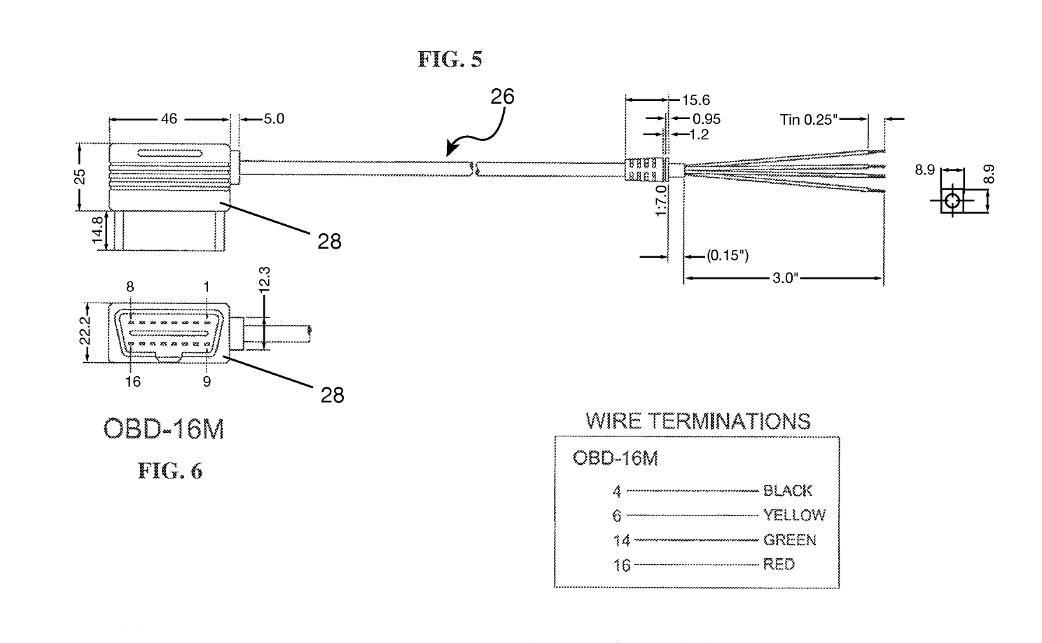

As shown in FIGS. 2 and 5-6, a cable assembly 26 is coupled to input circuitry in the housing 22 and terminates in a cable connector 28, which can mate with an on-board diagnostic (OBD) data link connector located in the cab of the vehicle. The data link connector outputs diagnostic information from the engine computer. In a presently preferred embodiment, the data link connector is an OBD-II connector, which is a female 16-pin connector and is located in the cab of the vehicle. The SAE J1962 specification, which is incorporated herein by this reference, defines the pinout of the OBD-II data link connector. The OBD-II connector standard is compatible with four distinct bit-serial electrical interfaces: SAE J1850 VPW, SAF J1850 PWM, ISO 9141-2, and ISO 15765 controller area network (CAN), which standards are incorporated herein by this reference.

In a presently preferred embodiment, the fuel usage meter is configured to operate with the CAN bus and to support Ford and GM OBD-II truck protocols. The pin-out information for the cable connector 28 that connects the fuel usage meter 20 to the OBD-II data link connector is as follows:

| Pin Number | Wire Color | Signal Name |
|---|---|---|
| 1 | | |
| 2 | | |
| 3 | | |
| 4 | BLACK | Ground |
| 5 | | |
| 6 | YELLOW | CAN-High (ISO 15765-4 and |
| | | SAE-J2284) |
| 7 | | |
| 8 | | |
| 9 | | |
| 10 | | |
| 11 | | |
| 12 | | |
| 13 | | |
| 14 | GREEN | CAN-Low (ISO 15765-4 and |
| | | SAE-J2284) |
| 15 | | |
| 16 | RED | Battery Voltage (+12 V) |

The OBD-II system monitors numerous parameters that can affect the emission performance of the vehicle and to assist repair technicians in diagnosing and fixing problems with the computerized engine controls, Among the data provided by the OBD-II system is the mass air flow (MAF) sensor rate, which represents the mass flow rate of air entering a fuel-injected internal combustion engine as measured by the mass air flow sensor. This air mass information is necessary for the engine control unit (ECU) to balance and deliver the correct fuel mass to the engine. Using the air mass flow information, the processor of the fuel usage meter 20 can calculate the fuel mass entering the engine, i.e. the fuel usage. The fuel usage meter can accumulate this calculated fuel usage and display the accumulated fuel usage on the meter digital display.

In operation, the fuel usage meter will continue accumulating fuel usage and will store that information in memory and display that accumulated usage until it is reset to zero by the driver. The processor will not reset by itself, even if power is lost, the engine is turned off or the meter is unplugged from the data link connector. To reset the meter, the user depresses and holds the reset until the display indicates a reset, e.g. by showing multiple dashes.

When a rental customer picks up the rental vehicle, he or she resets the fuel usage meter 1 using the reset button. The customer will then use the vehicle and use fuel. During that use, the fuel usage meter 10 will keep track of the fuel used. When the customer is done using the vehicle and is ready to return it, they can add the amount of fuel displayed on the meter to bring the level back to where it was at the start of the rental.

Upon reading this disclosure, those skilled in the art will appreciate that various changes and modifications may be made to the preferred embodiments of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for displaying an accumulated fuel usage to a driver of a rental vehicle, the method comprising:
providing a rental vehicle including a fuel usage meter, wherein the fuel usage meter comprises:
a digital display for displaying fuel consumption of a rental vehicle;
input circuitry coupled to a data bus of the vehicle for receiving on-board diagnostic data from an engine computer;
a processor coupled to the input circuitry and configured to calculate an accumulated fuel consumption using the on-board diagnostic data received from the engine computer;
a memory device coupled to the processor for storing data;
output circuitry coupled to the processor for outputting the accumulated fuel consumption to the digital display; and
a reset input coupled to the processor for resetting the accumulated fuel consumption display to zero;
wherein the processor and memory are configured to retain the accumulated fuel consumption until the reset input is manually activated;
displaying the fuel consumption of the rental vehicle to the customer with the fuel consumption meter;
instructing a rental customer to reset the accumulated fuel consumption display to zero when the customer takes possession of the vehicle; and
instructing the customer to read the accumulated fuel consumption display before returning the vehicle to determine an amount of fuel consumed during the rental of the vehicle.

2. The method of claim 1 wherein the processor and memory are configured to retain the accumulated fuel consumption when the engine is turned off.

3. The method of claim 1 wherein the processor and memory are configured to retain the accumulated fuel consumption when the fuel usage meter is uncoupled from the data bus of the vehicle.

4. The method of claim 1 wherein the processor and memory are configured to retain the accumulated fuel consumption when vehicle power is disconnected from the fuel usage meter.

5. The method of claim 1 wherein the fuel usage meter is configured to calculate and display fuel consumption in hundredths of units.

6. The method of claim 1 wherein the fuel usage meter digital display is mounted above the dashboard of the vehicle.

7. A method for modifying a rental vehicle to be rented to a customer, the method comprising:
installing in the rental vehicle a fuel usage meter, wherein the fuel usage meter comprises:
a digital display for displaying fuel consumption of a rental vehicle;
input circuitry coupled to a data bus of the vehicle for receiving on-board diagnostic data from an engine computer;
a processor coupled to the input circuitry and configured to calculate an accumulated fuel consumption using the on-board diagnostic data received from the engine computer;
a memory device coupled to the processor for storing data;
output circuitry coupled to the processor for outputting the accumulated fuel consumption to the digital display; and
a reset input coupled to the processor for resetting the accumulated fuel consumption display to zero;
wherein the processor and memory are configured to retain the accumulated fuel consumption until the reset input is manually activated.

8. The method of claim 7 further comprising instructing the customer to read the accumulated fuel consumption display before returning the vehicle to determine an amount of fuel consumed during the rental of the vehicle.

9. The method of claim 7 wherein the processor and memory are configured to retain the accumulated fuel consumption when the engine is turned off.

10. The method of claim 7 wherein the processor and memory are configured to retain the accumulated fuel consumption when the fuel usage meter is uncoupled from the data bus of the vehicle.

11. The method of claim 7 wherein the processor and memory are configured to retain the accumulated fuel consumption when vehicle power is disconnected from the fuel usage meter.

12. A fuel usage meter for displaying accumulated fuel usage to a driver of a rental vehicle, the fuel usage meter comprising:
a digital display for displaying fuel consumption of a rental vehicle;
input circuitry coupled to a data bus of the vehicle for receiving on-board. diagnostic data from an engine computer;
a processor coupled to the input circuitry and configured to calculate accumulated fuel consumption using the on-board diagnostic data received from the engine computer;
a memory device coupled to the processor for storing data;
output circuitry coupled to the processor for outputting the accumulated fuel consumption to the digital display; and
a reset input coupled to the processor for resetting the accumulated fuel consumption to zero;
wherein the processor and memory are configured to retain the accumulated fuel consumption until the reset input is manually activated; and
wherein the processor and memory are configured to retain the accumulated fuel consumption when vehicle power is disconnected from the fuel usage meter.

13. The fuel usage meter of claim 12 wherein the processor and memory are configured to retain the accumulated fuel consumption when the engine is turned off.

14. The fuel usage meter of claim 12 wherein the processor and memory are configured to retain the accumulated fuel consumption when the fuel usage meter is uncoupled from the data bus of the vehicle.

15. The fuel usage meter of claim 12 wherein accumulated the accumulated fuel usage is calculated using vehicle mass air flow data.

16. The fuel usage meter of claim 12 wherein the fuel usage meter is configured to calculate and display fuel consumption in hundredths of units.

17. The fuel usage meter of claim 12 wherein the data bus comprises a controller area network bus.

18. The fuel usage meter of claim 12 wherein the fuel usage meter digital display is mounted above the dashboard of the vehicle.

19. The fuel usage meter of claim 12 wherein the rental vehicle is a truck.
